(19) United States
(12) Patent Application Publication
(10) Pub. No.: US 2004/0208526 A1
(43) Pub. Date: Oct. 21, 2004

(54) Optical transmitter and receiver

(76) Inventor: Takahiko Mibu, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/082,100

(22) Filed: Feb. 26, 2002

(30) Foreign Application Priority Data
Dec. 28, 2001 (JP) 2001-401471

(51) Int. Cl. H04B 10/00

(52) U.S. Cl. 398/33

(57) ABSTRACT

There is provided an optical transmitter and receiver that delivers a radio signal received from outside the optical transmitter and receiver to a wireless demodulation circuit (16). A control circuit (10) controls a drive circuit (4) according to the radio signal. The optical transmitter and receiver sends an optical signal which is emitted according to a driving current from the drive circuit (4) by a light emitting element (5) into an optical cable (1a). A regenerating circuit (7) converts an optical signal received by way of another optical cable (1b) into received data and a wireless modulation circuit (22) modulates a carrier wave with the received data so as to generate a radio signal and then outputs the radio signal to outside the optical transmitter and receiver by way of an antenna (15).

### BACKGROUND OF THE INVENTION

1. Field of the Invention

The present invention relates to an optical transmitter and receiver that performs information transmission by using an optical fiber cable.

2. Description of the Prior Art

FIG. 4 is a block diagram showing the structure of a prior art optical transmitter and receiver. In the figure, reference characters 1a and 1b denote optical fibers via which optical signals are transmitted, reference numeral 2 denotes a connector for connecting an external device or circuit, or the like with the optical transmitter and receiver so as to transfer information in the form of electrical signals, reference numeral 3 denotes incoming transmission data from the external device or circuit, or the like by way of the connector 2, reference numeral 4 denotes a drive circuit for supplying a driving current that causes conversion of the transmission data 3 into an optical signal, and also outputs a modulation supervisory signal 11, and reference numeral 5 denotes a light emitting element for generating an optical signal according to the driving current applied thereto from the drive circuit 4, and for sending the optical signal into the optical fiber 1a.

Reference numeral 6 denotes a light receiving element for converting an optical signal applied thereto by way of the optical fiber 1b into an electrical signal, and reference numeral 7 denotes a regenerating circuit for regenerating original information from the electrical signal output from the light receiving element 6 so as to generate received data 8, and for outputting a DC voltage corresponding to the amplitude of the electrical signal as an optical input level signal 12. The received data 8 is output from the regenerating circuit 7 to the external device or the like by way of the connector 2. Reference numeral 9 denotes a transmission control signal for controlling the transmission of the optical signal output from the light emitting element 5, the transmission control signal being input from the external device or the like to the optical transmitter and receiver by way of the connector 2 in the prior art, reference numeral 10 denotes a control circuit for controlling the operation of the drive circuit 4 according to the input transmission control signal 9, and reference numeral 13 denotes a monitoring circuit that, when the optical input level signal 12 decreases in level, generates a light cutoff information and then generates a monitor signal 14 which is a combination of the light cutoff information and the modulation supervisory signal 11.

In operation, the optical transmitter and receiver sends an optical signal into the optical fiber 1a according to the transmission control signal 9 which is delivered from the external device or the like to the control circuit 10 by way of the connector 2.

The control circuit 10 controls the operation of the drive circuit 4 according to the input transmission control signal 9 so that the drive circuit 4 generates a driving current according to the transmission data 3 applied thereto from the external device or the like by way of the connector 2 under control of the control circuit 10, and then outputs the driving current to the light emitting element 5. The light emitting element 5 converts the transmission data 3 into an equivalent optical signal according to the driving current applied thereto from the drive circuit 4, and then sends the optical signal into the optical fiber 1a.

On the other hand, the light receiving element 6 converts an incoming optical signal from the optical fiber 1b into an equivalent electrical signal, and then delivers the electrical signal to the regenerating circuit 7. The regenerating circuit 7 regenerates original information from the input electrical signal so as to generate received data 8, and then delivers the received data 8 to the external device or the like by way of the connector 2.

The monitoring circuit 13 receives the modulation supervisory signal 11 indicating a modulation status of the optical signal output from the drive circuit 4 and the optical input level signal 12 output from the regenerating circuit 7, so as to determine whether or not either the optical signal output from the light emitting element 5 or the optical signal applied to the light receiving element 6 is cut off, and then delivers a light cutoff signal indicating the determination result as the monitor signal 14 to the external device or the like by way of the connector 2.

Furthermore, a test and an adjustment are carried out on the optical transmitter and receiver in order to ensure desired functions and desired performance. Power consumption and various test data of the optical transmitter and receiver are recorded as results of the test and adjustment. Particularly, since the light emitting element 5 and the light receiving element 6 differ from each other in their characteristics, test and adjustment results such as a minimum receiver sensitivity and so on at which the error rate of the transmission data associated with the power of light output to the optical fiber 1a or the power of light input via the optical fiber 1b is equal to or less than a certain value have to be stored in a single storage means located outside the optical transmitter and receiver so that the storage means can be managed.

A prior art optical transmitter and receiver constructed as mentioned above is that a connector used for inputting and outputting electric signals from and to an external device or the like located outside the prior art optical transmitter and receiver is needed, and therefore advances in miniaturization of the optical transmitter and receiver and the external device or the like provided with the optical transmitter and receiver make the position where the connector is mounted and the area occupied by the connector become restrictions when the external device or the like into which the optical transmitter and receiver is incorporated is mounted on a system board or the like.

### SUMMARY OF THE INVENTION

The present invention is proposed to solve the above-mentioned problems, and it is therefore an object of the present invention to provide an optical transmitter and receiver that can be connected to an external device without having to use any connector, and that can therefore be easily downsized.

In accordance with an aspect of the present invention, there is provided an optical transmitter and receiver for converting a signal applied thereto from outside the optical transmitter and receiver into an optical signal so as to send the optical signal into an optical cable, and for converting an optical signal received by way of another optical cable into a signal so as to send the signal to outside the optical transmitter and receiver, the optical transmitter and receiver comprising: a radio signal input unit for extracting transmission data from a radio signal applied thereto from outside the optical transmitter and receiver; an optical signal transmitting unit for converting the transmission data output from the radio signal input unit into an optical signal so as to send the optical signal into the optical cable; an optical signal receiving unit for extracting data from an optical signal received by way of the other optical cable; a monitoring unit for monitoring a transmitting state in which the optical signal transmitting unit is placed and a receiving state in which the optical signal receiving unit is placed so as to generate a monitor signal; a multiplexer for multiplexing the data output from the optical signal receiving unit and the monitor signal output from the monitoring unit into reception information; and a radio signal output unit for converting the reception information output from the multiplexer into a radio signal and for outputting the radio signal to outside-the optical transmitter and receiver. Accordingly, the optical transmitter and receiver can be downsized, and restrictions imposed on the position where the optical transmitter and receiver is mounted and the area occupied by the optical transmitter and receiver can be reduced.

In accordance with another aspect of the present invention, the radio signal input unit includes an antenna for receiving a radio signal applied thereto from outside the optical transmitter and receiver, a demodulation unit for demodulating the received radio signal so as to generate transmission information, and a separation unit for separating the transmission information into transmission data, which is to be converted into an optical signal by the optical signal transmitting unit, and a transmission control signal used for controlling the optical signal transmitting unit.

In accordance with another aspect of the present invention, the radio signal output unit includes a modulation unit for modulating a carrier wave with the reception information output from the multiplexer so as to generate a radio signal, and an antenna for transmitting the radio signal output from the modulation unit to outside the optical transmitter and receiver.

In accordance with a further aspect of the present invention, the optical transmitter and receiver further comprises a storage unit for storing results of a test and an adjustment which are carried out on the optical transmitter and receiver. The multiplexer can multiplex the data output from the optical signal receiving unit, the monitor signal output from the monitoring unit, and the test and adjustment results into the reception information.

In accordance with another aspect of the present invention, the optical transmitter and receiver further comprises an identification information storage unit for storing identification information used for identifying the optical transmitter and receiver, and an identity detection unit for comparing identification information included in the transmission information with the identification information stored in the identification information storage unit, and for delivering the transmission information to the separation unit when the identification information included in the transmission information matches the identification information stored in the identification storage unit.

In accordance with a further aspect of the present invention, the optical transmitter and receiver further comprises an identification information storage unit for storing identification information used for identifying the optical transmitter and receiver. The multiplexer can multiplex the data output from the optical signal receiving unit, the monitor signal output from the monitoring unit, and the identification information into the reception information.

In accordance with another aspect of the present invention, there is provided an optical transmitter and receiver for converting a signal applied thereto from outside the optical transmitter and receiver into an optical signal so as to send the optical signal into an optical cable, and for converting an optical signal received by way of another optical cable into a signal so as to send the signal to outside the optical transmitter and receiver, the optical transmitter and receiver comprising: a spatial optical signal input unit for receiving a spatial optical signal emitted in an outside space, and for converting the spatial optical signal into transmission information; a separation unit for separating the transmission information output from the spatial optical signal input unit into transmission data and a transmission control signal; an optical signal transmitting unit for converting the transmission data into an optical signal according to the transmission control signal and for sending the optical signal into the optical cable; an optical signal receiving unit for converting an optical signal received by way of the other optical cable into data; a monitoring unit for monitoring a transmitting state in which the optical signal transmitting unit is placed and a receiving state in which the optical signal receiving unit is placed so as to generate a monitor signal; a multiplexer for multiplexing the data output from the optical signal receiving unit and the monitor signal output from the monitoring unit into reception information; and a spatial optical signal output unit for converting the reception information output from the multiplexer into a spatial optical signal and for emitting the spatial optical signal in the outside space. Accordingly, the optical transmitter and receiver can be downsized, and restrictions imposed on the position where the optical transmitter and receiver is mounted and the area occupied by the optical transmitter and receiver can be reduced.

In accordance with a further aspect of the present invention, the optical transmitter and receiver further comprises: a storage unit for storing results of a test and an adjustment which are carried out on the optical transmitter and receiver The multiplexer can multiplex the data output from the optical signal receiving unit, the monitor signal output from the monitoring unit, and the test and adjustment results into the reception information.

In accordance with another aspect of the present invention, the optical transmitter and receiver further comprises an identification information storage unit for storing identification information used for identifying the optical transmitter and receiver, and an identity detection unit for comparing identification information included in the transmission information with the identification information stored in the identification information storage unit, and for delivering the transmission information to the separation unit when the identification information included in the transmission information matches the identification information stored in the identification storage unit.

In accordance with another aspect of the present invention, the optical transmitter and receiver further comprises an identification information storage unit for storing identification information used for identifying the optical transmitter and receiver. The multiplexer can multiplex the data output from the optical signal receiving unit, the monitor signal output from the monitoring unit, and the identification information into the reception information.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of an optical transmitter and receiver according to a first embodiment of the present invention;

FIG. 2 is a block diagram showing the structure of an optical transmitter and receiver according to a second embodiment of the present invention;

FIG. 3 is a block diagram showing the structure of an optical transmitter and receiver according to a third embodiment of the present invention; and

FIG. 4 is a block diagram showing the structure of a prior art optical transmitter and receiver.

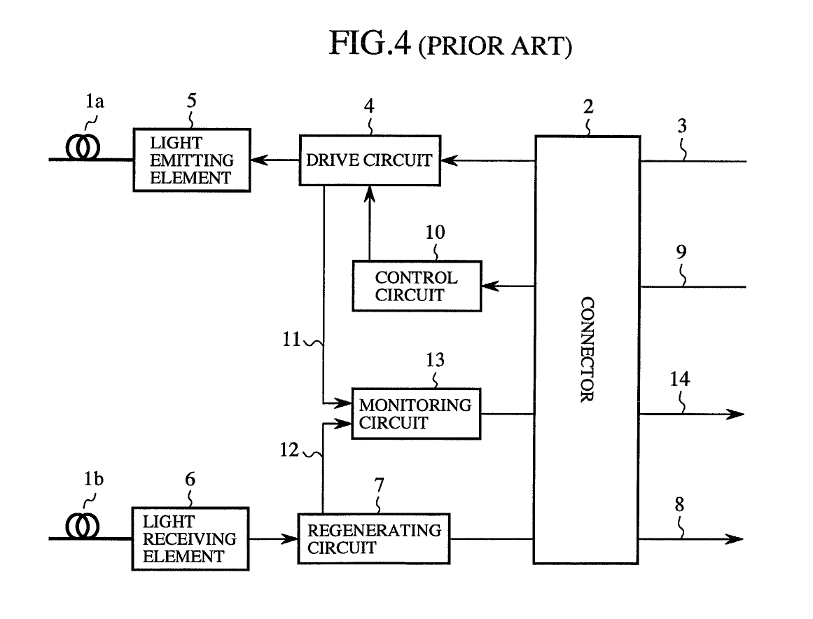

### DETAILED DESCRIPTION OF THE PREFERRED EMBODIMENTS

Embodiment 1.

An optical transmitter and receiver according to the present invention is included in a transmission system, such as a router, for performing network communications by using an optical fiber cable, for example. In addition, the optical transmitter and receiver uses radio signals as an interface between each apparatus or circuit, or the like which constitutes the transmission system, i.e., an external device or the like and the optical transmitter and receiver in accordance with the Bluetooth wireless specification or the like. An optical transmitter and receiver according to the first embodiment uses a radio signal, such as a given electric wave, as an interface with an apparatus or circuit adjacent to the optical transmitter and receiver.

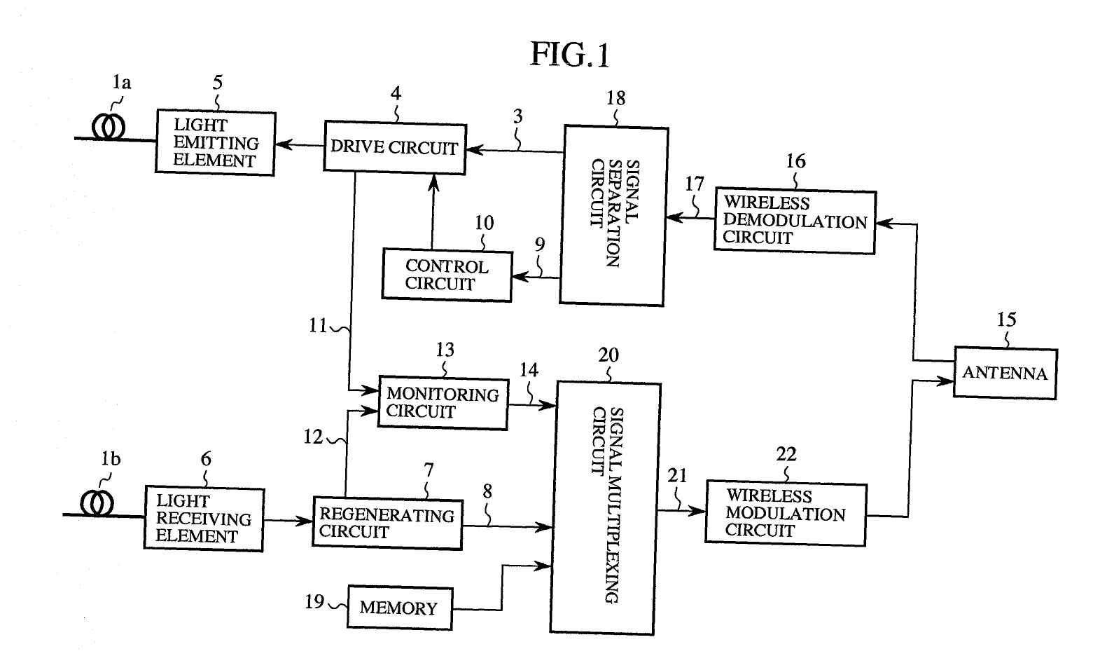

FIG. 1 is a block diagram showing the structure of the optical transmitter and receiver according to the first embodiment of the present invention. In the figure, reference characters 1a and 1b denote optical fibers via which optical signals are transmitted, reference numeral 3 denotes transmission data that is to be converted into an optical signal and that is to be output from the optical transmitter and receiver to the optical fiber 1a, and reference numeral 4 denotes a drive circuit that generates a driving current corresponding to the transmission data 3 under control of a control circuit 10, and outputs the driving current to a light emitting element 5, and that generates a modulation supervisory signal 11 and outputs it to a monitoring circuit 13. The light emitting element 5 generates and sends an optical signal according to the driving current applied thereto from the drive circuit 4 into the optical fiber 1a.

Reference numeral 6 denotes a light receiving element that receives an optical signal applied thereto by way of the optical fiber 1b and that converts the optical signal into an equivalent electrical signal, reference numeral 7 denotes a regenerating circuit for regenerating original information from the electrical signal output from the light receiving element 6 so as to generate received data 8, and for outputting a DC voltage corresponding to the amplitude of the electrical signal which indicates a receiving state as an optical input level signal 12, reference numeral 9 denotes a transmission control signal used for controlling the transmission of the optical signal output from the light emitting element 5 such that the transmission is carried out or stopped, reference numeral 10 denotes a control circuit for controlling the drive circuit 4 according to the transmission control signal 9 such that the drive circuit 4 performs or stops modulation, reference numeral 11 denotes modulation monitor information indicating a modulation status (i.e., transmission status) of an optical signal output from the drive circuit 4, and reference numeral 13 denotes a monitoring circuit that, when the optical input level signal 12 decreases in level, generates light cutoff information and then generates and delivers a monitor signal 14 which is a combination of the light cutoff information and the modulation supervisory signal 11 to a signal multiplexing circuit 20.

Reference numeral 15 denotes an antenna for sending and receiving radio signals, reference numeral 16 denotes a wireless demodulation circuit for demodulating the radio signal received by the antenna 15 so as to regenerate original information, reference numeral 17 denotes regeneration transmission information output from the wireless demodulation circuit 16, reference numeral 18 denotes a signal separation circuit for separating the regeneration transmission information 17 into the transmission data 3 and the transmission control signal 9, and reference numeral 19 denotes a memory for storing results of a test and an adjustment carried out on the optical transmitter and receiver according to the first embodiment of the present invention, the test and adjustment results including the amount of current flowing through the optical transmitter and receiver, the power of light output from the optical transmitter and receiver, and a minimum receiver sensitivity. The signal multiplexing circuit 12 multiplexes the received data 8 and the monitor signal 14 together with the test and adjustment results stored in the memory 19 into transmission and reception information 21. Reference numeral 22 denotes a wireless modulation circuit for modulating a carrier wave with the transmission and reception information 21 from the signal multiplexing circuit 12 so as to generate a radio signal and for outputting the radio signal to the antenna 15.

In operation, the optical transmitter and receiver receives a radio signal sent from outside the optical transmitter and receiver by way of the antenna 15 and outputs the received radio signal to the wireless demodulation circuit 16. The wireless demodulation circuit 16 regenerates original information from the input radio signal so as to generate regeneration transmission information 17. The signal separation circuit 18 receives the regeneration transmission information 17 and then separates the regeneration transmission information 17 into transmission data 3 and a transmission control signal 9. The signal separation circuit 18 outputs the transmission data 3 to the drive circuit 4, and, furthermore, outputs the transmission control signal 9 to the control circuit 10. Then, the control circuit 10 controls the drive circuit 4 according to the transmission control signal 9 so as to cause the drive circuit 4 to generate a driving current for driving the light emitting element 5. The drive circuit 4 generates the driving current corresponding to the transmission data 3 applied thereto from the signal separation circuit 18 under control of the control circuit 10, and outputs the driving current to the light emitting element 5. The light emitting element 5 generates an optical signal according to the input driving current, and sends the optical signal into the optical fiber 1a. While the drive circuit 4 allows the light emitting element 5 to operate according to the driving current, the drive circuit 4 also generates and outputs a modulation supervisory signal 11 indicating a modulation status of the optical signal output from the light emitting element 5 to the monitoring circuit 13.

On the other hand, an optical signal input to the optical transmitter and receiver by way of the optical fiber 1b is received by the light receiving element 6. The light receiving element 6 converts the input optical signal into an equivalent electrical signal and outputs it to the regenerating circuit 7. The regenerating circuit 7 regenerates original information from the input electrical signal so as to generate received data 8, and generates and outputs an optical input level signal 12 indicating the amplitude of the electrical signal to the monitoring circuit 13. The received data 8 output from the regenerating circuit 7 is input to the signal multiplexing circuit 20. The signal multiplexing circuit 20 reads the test and adjustment results stored in the memory 19 and receives the received data 8 output from the regenerating circuit 7 and the monitor signal 14 output from the monitoring circuit 13. The signal multiplexing circuit 20 then multiplexes the test and adjustment results of the optical transmitter and receiver, the received data 8, and the monitor signal 14 into transmission and reception information 21. The wireless modulation circuit 22 modulates a carrier wave with the transmission and reception information 21 output from the signal multiplexing circuit 20 so as to generate a radio signal and sends the radio signal to the antenna 15. The antenna 15 then outputs the radio signal to outside the optical transmitter and receiver.

As mentioned above, in accordance with the first embodiment, since the optical transmitter and receiver transfers information between itself and an external device or the like by using a radio signal, no connector for connecting the optical transmitter and receiver with the external device or the like is needed, and therefore the optical transmitter and receiver can be downsized and restrictions imposed on the position where the optical transmitter and receiver is mounted and the area occupied by the optical transmitter and receiver can be reduced.

Furthermore, since results of a test and an adjustment carried out on the optical transmitter and receiver, such as the amount of current flowing through the optical transmitter and receiver, the power of light output from the optical transmitter and receiver, and a minimum receiver sensitivity, are stored in the memory 19, and the test and adjustment results are multiplexed into transmission and reception information together with the received data 8 and the monitor signal 14 and a radio signal corresponding to the transmission and reception information is then output, the test and adjustment results can be easily acquired and therefore information on the optical transmitter and receiver can be promptly acquired.

Embodiment 2.

An optical transmitter and receiver according to a second embodiment of the present invention has a spatial optical signal regenerating circuit 23 and a spatial optical signal generation circuit 24 instead of the antenna 15, the wireless demodulation circuit 16, and the wireless modulation circuit 22 disposed within the optical transmitter and receiver according to the above-mentioned first embodiment. The optical transmitter and receiver according to the second embodiment of the present invention sends and receives information to and from an external device or the like by using a spatial optical signal instead of a radio signal. The other structure of the optical transmitter and receiver according to the second embodiment is the same as that of the above-mentioned first embodiment.

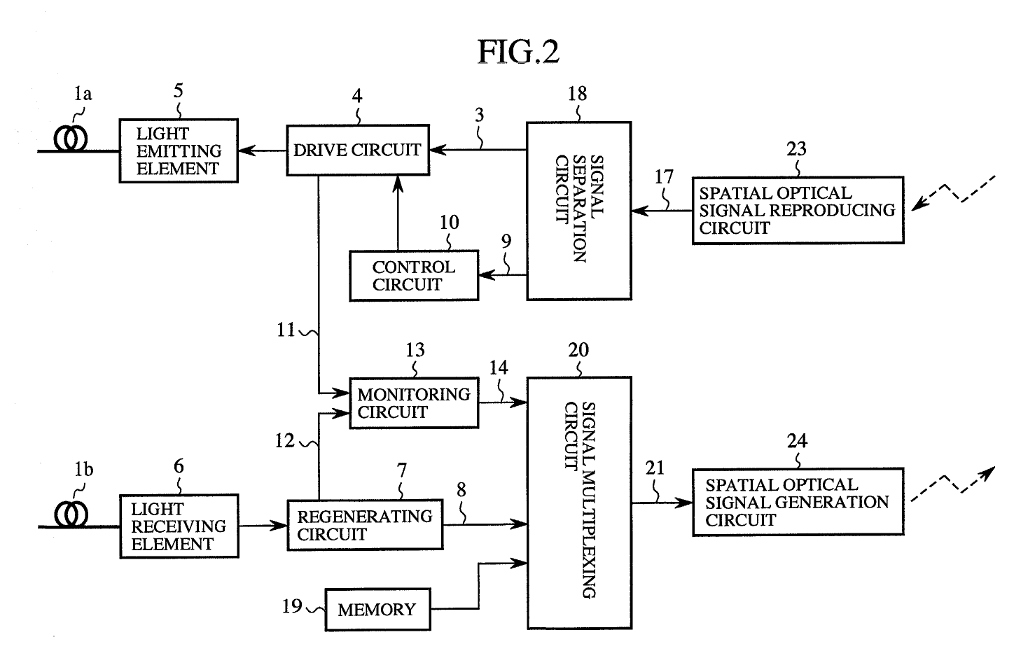

FIG. 2 is a block diagram showing the structure of the optical transmitter and receiver according to the second embodiment of the present invention. The same components as those of the optical transmitter and receiver according to the first embodiment shown in FIG. 1 or like components are designated by the same reference numerals, and therefore the explanation of those components will be omitted hereafter. The spatial optical signal regenerating circuit 23 receives an optical signal emitted out of an external device or the like in a space where the optical transmitter and receiver and the external device or the like are arranged, and then generates regeneration transmission information 17 from the optical signal. The spatial optical signal generation circuit 24 converts transmission and reception information 21 output from a signal multiplexing circuit 20 into an optical signal, and then emits the optical signal in a direction from the optical transmitter and receiver to the external device or the like in the space where the optical transmitter and receiver and the external device or the like are arranged.

In operation, in a transmission system, such as a router, including the optical transmitter and receiver according to the second embodiment, for example, the optical transmitter and receiver uses an optical signal emitted out in a space, as an interface between another apparatus or circuit, or the like which constitutes the transmission system, i.e., an external device or the like and the optical transmitter and receiver.

The optical transmitter and receiver according to the second embodiment of the present invention has the spatial optical signal regenerating circuit 23 and the spatial optical signal generation circuit 24 instead of the antenna 15, the wireless demodulation circuit 16, and the wireless modulation circuit 22 disposed within the optical transmitter and receiver according to the above-mentioned first embodiment, as previously mentioned, and the other components operate in the same way that those of the optical transmitter and receiver according to the above-mentioned first embodiment do. Hereafter, an operation different from that of the optical transmitter and receiver of the first embodiment will be explained.

The spatial optical signal regenerating circuit 23 converts a received spatial optical signal into regeneration transmission information 17, and outputs it to the signal separation circuit 18. The signal separation circuit 18 separates the input regeneration transmission information 17 into transmission data 3 and a transmission control signal 9, and then outputs the transmission data 3 to a drive circuit 4, and, furthermore, outputs the transmission control signal 9 to a control circuit 10. After that, the control circuit 10, the drive circuit 4, and a light emitting element 5 operate in the same way that the control circuit 10, the drive circuit 4, and the light emitting element 5 of the optical transmitter and receiver according to the above-mentioned first embodiment do. As a result, an optical signal is sent out from the light emitting element 5 into an optical fiber la.

On the other hand, an optical signal input to the optical transmitter and receiver by way of another optical fiber 1b is received by a light receiving element 6. After that, the light receiving element 6 and a regenerating circuit 7 of the optical transmitter and receiver according to the second embodiment operate in the same way that the light receiving element 6 and the regenerating circuit 7 of the optical transmitter and receiver according to the above-mentioned first embodiment do. In other words, the regenerating circuit 7 converts the optical signal received by the light receiving element 6 into an equivalent electrical signal so as to generate received data 8, generates an optical input level signal 12, and, furthermore, outputs it to a monitoring circuit 13. The received data 8 output from the regenerating circuit 7 is input to the signal multiplexing circuit 20 together with results of a test and an adjustment stored in the memory 19 and a monitor signal 14 output from the monitoring circuit 13. The signal multiplex circuit 20 multiplexes the test and adjustment results of the optical transmitter and receiver, the received data 8, and the monitor signal 14 into transmission and reception information 21, and outputs it to the spatial optical signal generation circuit 24. The spatial optical signal generation circuit 24 then converts the input transmission and reception information 21 into an optical signal, and emits this optical signal toward the external device or the like in a space.

As mentioned above, in accordance with the second embodiment, since the optical transmitter and receiver transfers information between itself and an external device or the like by using a spatial optical signal, no connector for connecting the optical transmitter and receiver with the external device or the like is needed, and therefore the optical transmitter and receiver can be downsized and restrictions imposed on the position where the optical transmitter and receiver is mounted and the area occupied by the optical transmitter and receiver can be reduced.

Furthermore, since results of a test and an adjustment carried out on the optical transmitter and receiver, such as the amount of current flowing through the optical transmitter and receiver, the power of light output from the optical transmitter and receiver, and a minimum receiver sensitivity, are stored in the memory 19, and the test and adjustment results are multiplexed into transmission and reception information together with the received data 8 and the monitor signal 14 and a radio signal corresponding to the transmission and reception information is then output, the test and adjustment results can be easily acquired and therefore information on the optical transmitter and receiver can be promptly acquired.

Embodiment 3.

An optical transmitter and receiver according to a third embodiment is provided with an identification information storage unit 25 and an identity detector 26 in addition to the same components as those of the above-mentioned first embodiment, and therefore the other components of the optical transmitter and receiver according to the third embodiment are constructed in the same way.

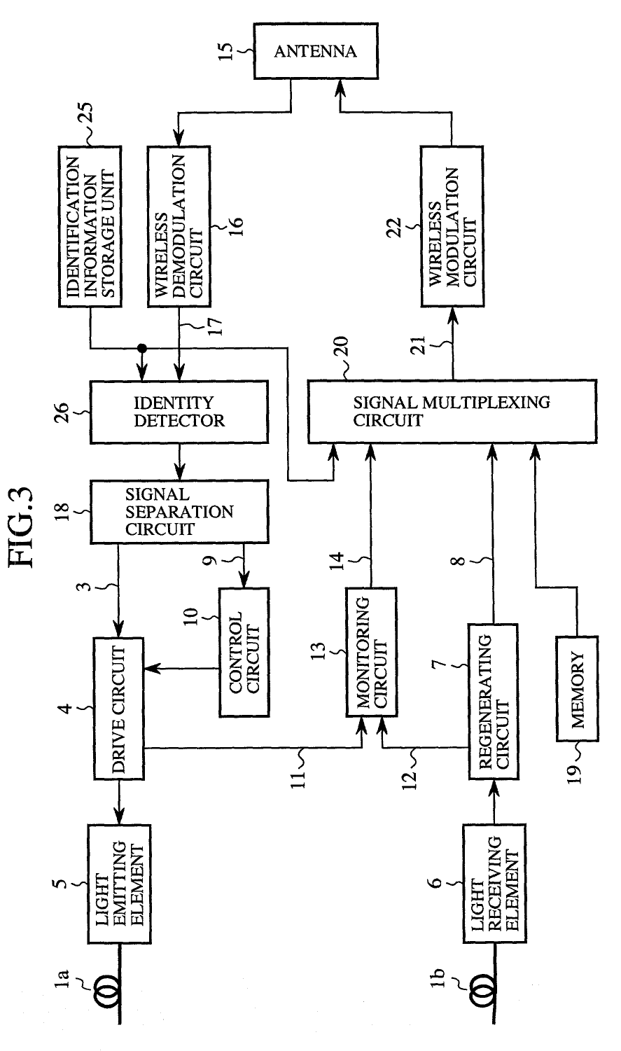

FIG. 3 is a block diagram showing the structure of the optical transmitter and receiver according to the third SIX embodiment of the present invention. The same components as those of the optical transmitter and receiver according to the first embodiment shown in FIG. 1 or like components are designated by the same reference numerals, and therefore the explanation of those components will be omitted hereafter. The identification information storage unit 25 consists of flip-flops and so on, and stores identification information defined for the optical transmitter and receiver, the identification information being a combination of a plurality of pieces of data information of 1 or 0. The identification information storage unit 25 outputs the stored identification information to the identity detector 26 and a signal multiplexing circuit 20 as required. The identity detector (identity detection unit) 26 compares the identification information applied thereto from the identification information storage unit 25 with identification information included in regeneration transmission information 17 applied thereto from a wireless demodulation circuit 16 and then outputs the regeneration transmission information 17 to a signal separation circuit 18 only when the identification information input from the identification information storage unit 25 matches the identification information included in the regeneration transmission information 17 input from the wireless demodulation circuit 16. In the third embodiment, the regeneration transmission information 17, which is acquired from an external device or the like, is a combination of transmission data 3, a transmission control signal 9, and the identification information used for the identification of the optical transmitter and receiver.

In operation, when manufacturing and shipping each optical transmitter and receiver according to the third embodiment of the present invention, an identification number is stored in the identification information storage unit 25 of each optical transmitter and receiver. An external device or the like generates and outputs a radio signal into which identification information identifying a desired optical transmitter and receiver and a combination of transmission data 3 and a transmission control signal 9 are multiplexed in order to specify the desired optical transmitter and receiver which will convert the transmission data 3 into an optical signal. When the radio signal output from the external device or the like is input to the wireless demodulation circuit 16 by way of an antenna 15, the wireless demodulation circuit 16 regenerates original information from the radio signal so as to generate regeneration transmission information 17, and then outputs the regeneration transmission information 17 to the identity detector 26. The identity detector 26 reads the identification information stored in the identification information storage unit 25, and compares this identification information with the identification information included in the regeneration transmission information 17 applied thereto from the wireless demodulation circuit 16. The identity detector 26 outputs the regeneration transmission information 17 including the identification information to the signal separation circuit 18 only when the identification information read out of the identification information storage unit 25 matches the identification information included in the regeneration transmission information 17 input from the wireless demodulation circuit 16.

The signal separation circuit 18 separates the regeneration transmission information 17 from the identity detector 26 into the identification information, the transmission data 3, and the transmission control signal 9, outputs the transmission data 3 to a drive circuit 4, and, furthermore, outputs the transmission control signal 9 to a control circuit 10. After that, the control circuit 10, the drive circuit 4, and a light emitting element 5 operate in the same manner that the control circuit 10, the drive circuit 4, and the light emitting element 5 of the optical transmitter and receiver according to the above-mentioned first embodiment do. As a result, an optical signal, into which the transmission data 3 is converted, is output from the light emitting element 5 to an optical fiber la.

In contrast, when the identification information read out of the identification information storage unit 25 does not match the identification information included in the regeneration transmission information 17 input from the wireless demodulation circuit 16, since the identity detector 26 does not output the regeneration transmission information 17 including the identification information to the signal separation circuit 18, no optical signal is sent into the optical fiber 1a.

On the other hand, an optical signal input to the optical transmitter and receiver by way of another optical fiber 1b is received by a light receiving element 6. The light receiving element 6 and a regenerating circuit 7 operate in the same manner that the light receiving element 6 and the regenerating circuit 7 of the optical transmitter and receiver according to the first embodiment do, and therefore the regenerating circuit 7 generates received data 8 based on the output of the light receiving element 6 which has received the optical signal. The regenerating circuit 7 generates an optical input level signal 12 and outputs it to a monitoring circuit 13. The received data 8 output from the regenerating circuit 7 is input to the signal multiplexing circuit 20 together with results of a test and an adjustment stored in a memory 19, a monitor signal 14 output from the monitoring circuit 13, and the identification information stored in the identification information storage unit 25. The signal multiplexing circuit 20 multiplexes the input test and adjustment results, the received data 8, the monitor signal 14, and the identification information into transmission and reception information 21, and outputs the transmission and reception information 21 to the wireless modulation circuit 22. The wireless modulation circuit 22 modulates a carrier wave with the input transmission and reception information 21 so as to convert it into a radio signal, and outputs the radio signal to outside the optical transmitter and receiver by way of the antenna 15 so as to send the radio signal to the external device or the like.

In the above-mentioned third embodiment, the optical transmitter and receiver is provided with the identification information storage unit 25 and the identity detector 26 in addition to the structure of the optical transmitter and receiver according to the above-mentioned first embodiment. As an alternative, the optical transmitter and receiver can be provided with the identification information storage unit 25 and the identity detector 26 in addition to the structure of the optical transmitter and receiver according to the above-mentioned second embodiment, and can deliver identification information to the signal multiplexing circuit 20 so as to allow the signal multiplexing circuit 20 to multiplex the identification information, the received data 8, and the monitor signal 14 into the transmission and reception information 21, thereby providing the same advantages as offered by the above-mentioned third embodiment.

As mentioned above, in accordance with the third embodiment, the optical transmitter and receiver compares the identification information stored in the identification information storage unit 25 with identification information included in the regeneration transmission information 17 by means of the identity detector 26, converts the regeneration transmission information 17 into an optical signal when the identification information stored in the identification information storage unit 25 matches the identification information included in the regeneration transmission information 17, and sends the optical signal into the optical fiber 1a, and, furthermore, converts an optical signal applied thereto by way of the optical fiber 1b into an electrical signal, and sends transmission and reception information 21 into which the identification information of the optical transmitter and receiver is multiplexed together with received data 8, a monitor signal 14, and test and adjustment results to an external device or the like. Accordingly, the external device or the like can transfer information while individually managing a plurality of optical transmitter and receivers, and therefore information can be transfer between each of the plurality of optical transmitter and receivers and the external device or the like by using radio signals while jamming is avoided.

In addition, since the optical transmitter and receiver transfers information between itself and the external device or the like by using radio signals, no connector for connecting the optical transmitter and receiver with the external device or the like is needed, and therefore the optical transmitter and receiver can be downsized and restrictions imposed on the position where the optical transmitter and receiver is mounted and the area occupied by the optical transmitter and receiver can be reduced.

Furthermore, since results of a test and an adjustment carried out on the optical transmitter and receiver, such as the amount of current flowing through the optical transmitter and receiver, the power of light output from the optical transmitter and receiver, and a minimum receiver sensitivity, are stored in the memory 19, and the test and adjustment results are multiplexed into transmission and reception information together with the received data 8 and the monitor signal 14 and a radio signal corresponding to the transmission and reception information is then output, the test and adjustment results can be easily acquired and therefore information on the optical transmitter and receiver can be promptly acquired.

Many widely different embodiments of the present invention may be constructed without departing from the spirit and scope of the present invention. It should be understood that the present invention is not limited to the specific embodiments described in the specification, except as defined in the appended claims.

What is claimed is:

1. An optical transmitter and receiver for converting a signal applied thereto from outside said optical transmitter and receiver into an optical signal so as to send the optical signal into an optical cable, and for converting an optical signal received by way of another optical cable into a signal so as to send the signal to outside said optical transmitter and receiver, said optical transmitter and receiver comprising:
a radio signal input unit for extracting transmission data from a radio signal applied thereto from outside said optical transmitter and receiver;
an optical signal transmitting unit for converting the transmission data output from said radio signal input unit into an optical signal so as to send the optical signal into said optical cable;
an optical signal receiving unit for extracting data from an optical signal received by way of said other optical cable;
a monitoring unit for monitoring a transmitting state in which said optical signal transmitting unit is placed and a receiving state in which said optical signal receiving unit is placed so as to generate a monitor signal;
a multiplexer for multiplexing the data output from said optical signal receiving unit and the monitor signal output from said monitoring unit into reception information; and
a radio signal output unit for converting the reception information output from said multiplexer into a radio signal and for outputting the radio signal to outside said optical transmitter and receiver.

2. The optical transmitter and receiver according to claim 1, wherein said radio signal input unit includes an antenna for receiving a radio signal applied thereto from outside said optical transmitter and receiver, a demodulation unit for demodulating the received radio signal so as to generate transmission information, and a separation unit for separating the transmission information into transmission data, which is to be converted into an optical signal by said optical signal transmitting unit, and a transmission control signal used for controlling said optical signal transmitting unit.

3. The optical transmitter and receiver according to claim 1, wherein said radio signal output unit includes a modulation unit for modulating a carrier wave with the reception information output from said multiplexer so as to generate a radio signal, and an antenna for transmitting the radio signal output from said modulation unit to outside said optical transmitter and receiver.

4. The optical transmitter and receiver according to claim 1, further comprising: a storage unit for storing results of a test and an adjustment which are carried out on said optical transmitter and receiver, wherein said multiplexer multiplexes the data output from said optical signal receiving unit, the monitor signal output from said monitoring unit, and the test and adjustment results into the reception information.

5. The optical transmitter and receiver according to claim 2, further comprising an identification information storage unit for storing identification information used for identifying said optical transmitter and receiver, and an identity detection unit for comparing identification information included in the transmission information with the identification information stored in said identification information storage unit, and for delivering the transmission information to said separation unit when the identification information included in the transmission information matches the identification information stored in said identification storage unit.

6. The optical transmitter and receiver according to claim 1, further comprising an identification information storage unit for storing identification information used for identifying said optical transmitter and receiver, wherein said multiplexer multiplexes the data output from said optical signal receiving unit, the monitor signal output from said monitoring unit, and the identification information into the reception information.

7. An optical transmitter and receiver for converting a signal applied thereto from outside said optical transmitter and receiver into an optical signal so as to send the optical signal into an optical cable, and for converting an optical signal received by way of another optical cable into a signal so as to send the signal to outside said optical transmitter and receiver, said optical transmitter and receiver comprising:
a spatial optical signal input unit for receiving a spatial optical signal emitted in an outside space, and for converting the spatial optical signal into transmission information;
a separation unit for separating the transmission information output from said spatial optical signal input unit into transmission data and a transmission control signal;
an optical signal transmitting unit for converting the transmission data into an optical signal according to the transmission control signal and for sending the optical signal into said optical cable;
an optical signal receiving unit for converting an optical signal received by way of said other optical cable into data;
a monitoring unit for monitoring a transmitting state in which said optical signal transmitting unit is placed and a receiving state in which said optical signal receiving unit is placed so as to generate a monitor signal;
a multiplexer for multiplexing the data output from said optical signal receiving unit and the monitor signal output from said monitoring unit into reception information; and
a spatial optical signal output unit for converting the reception information output from said multiplexer into a spatial optical signal and for emitting the spatial optical signal in the outside space.

8. The optical transmitter and receiver according to claim 7, further comprising: a storage unit for storing results of a test and an adjustment which are carried out on said optical transmitter and receiver, wherein said multiplexer multiplexes the data output from said optical signal receiving unit, the monitor signal output from said monitoring unit, and the test and adjustment results into the reception information.

9. The optical transmitter and receiver according to claim 7, further comprising an identification information storage unit for storing identification information used for identifying said optical transmitter and receiver, and an identity detection unit for comparing identification information included in the transmission information with the identification information stored in said identification information storage unit, and for delivering the transmission information to said separation unit when the identification information included in the transmission information matches the identification information stored in said identification storage unit.

10. The optical transmitter and receiver according to claim 7, further comprising an identification information storage unit for storing identification information used for identifying said optical transmitter and receiver, wherein said multiplexer multiplexes the data output from said optical signal receiving unit, the monitor signal output from said monitoring unit, and the identification information into the reception information.
